(19) United States
(12) Patent Application Publication
(10) Pub. No.: US 2025/0142685 A1
(43) Pub. Date: May 1, 2025

(54) HEATING COOKER

(71) Applicant: SHARP KABUSHIKI KAISHA, Sakai City (JP)

(72) Inventors: SHINJI ASAMI, Sakai City (JP); Mariko YACHI, Sakai City (JP)

(21) Appl. No.: 18/925,283

(22) Filed: Oct. 24, 2024

(30) Foreign Application Priority Data
Oct. 31, 2023 (JP) 2023-186343

(51) Int. Cl. H05B 6/64

(52) U.S. Cl. CPC H05B 6/6444; H05B 6/6473

(57) ABSTRACT

A heating cooker includes a heating cooking compartment, an upper wall, an irradiator, and a reflector. The heating cooking compartment allows a heating-target object to be accommodated therein. The upper wall constitutes at least a part of the heating cooking compartment. The irradiator is disposed on an outer side of the heating cooking compartment with respect to an upper wall and irradiates an inside of the heating cooking compartment with light from an outside of the heating cooking compartment. The reflector is disposed at a position on the upper wall opposite to the heating cooking compartment, and reflects light emitted from the irradiator. The upper wall has a first opening configured to allow light emitted from the irradiator to pass through, and a second opening configured to allow light reflected from the reflector to pass through.

### BACKGROUND OF THE INVENTION

### 1. Technical Field

The present disclosure relates to a heating cooker.

### 2. Description of the Related Art

JP 2001-311519 A discloses a heating cooker. The heating cooker disclosed in JP 2001-311519 A includes a ceiling intake port and an interior lighting. The ceiling intake port is disposed at a front part of a ceiling plate of an inner box. The interior lighting illuminates an inside of a heating compartment with light passing through the ceiling intake port.

### SUMMARY OF THE INVENTION

However, in the heating cooker disclosed in JP 2001-311519 A, since the interior lighting is disposed outside the inner box, there is light that does not pass through the ceiling intake port. As a separation distance between the interior lighting and the ceiling intake port increases, an amount of light that cannot pass through the ceiling intake port increases. Hence, there is a possibility that the amount of light with which the inside of the heating compartment is irradiated will be decreased.

In view of the above problem, an object of the present disclosure is to provide a heating cooker capable of increasing an amount of light with which an inside of a heating cooking compartment is irradiated.

According to one aspect of the present disclosure, a heating cooker includes a heating cooking compartment, a wall portion, an irradiator, and a reflector. The heating cooking compartment accommodates a heating-target object. The wall portion constitutes at least a part of the heating cooking compartment. The irradiator is disposed on an outer side of the heating cooking compartment with respect to the wall portion and irradiates an inside of the heating cooking compartment with light from an outside of the heating cooking compartment. The reflector is disposed at a position on the wall portion opposite to the heating cooking compartment and reflects light emitted from the irradiator. The wall portion has a first opening configured to allow light emitted from the irradiator to pass through, and a second opening configured to allow light reflected from the reflector to pass through.

According to the heating cooker of the present disclosure, an amount of light with which the inside of the heating cooking compartment is irradiated can be increased.

### BRIEF DESCRIPTION OF THE DRAWINGS

FIG. 1 is a perspective view illustrating a heating cooker according to an embodiment of the present disclosure;

FIG. 2 is a perspective view illustrating the heating cooker in a state where a part of a housing is removed according to the embodiment;

FIG. 3 is a perspective view illustrating the heating cooker in a state where a part of the housing is removed according to the embodiment;

FIG. 4 is a perspective view illustrating a door according to the embodiment;

FIG. 5 is a view illustrating a schematic cross section of the heating cooker according to the embodiment;

FIG. 6 is a view illustrating a schematic cross section of an air blower according to the embodiment;

FIG. 7 is a perspective view illustrating the heating cooker in a state where the housing except for a front wall thereof is removed according to the embodiment;

FIG. 8 is a plan view illustrating the heating cooker in a state where the housing and a control board are removed according to the embodiment;

FIG. 9 is an enlarged view of a region IX in FIG. 5;

FIG. 10 is a plan view illustrating a part of an upper wall in a state where an irradiator and a holder are removed according to the embodiment;

FIG. 11 is an exploded perspective view illustrating a mounting structure of the irradiator;

FIG. 12 is a descriptive view for illustrating a traveling path of irradiation light;

FIG. 13 is a perspective view illustrating a flow channel section according to the embodiment;

FIG. 14 is a plan view illustrating the flow channel section according to the embodiment; and

FIG. 15 is a block diagram illustrating a configuration of the heating cooker according to the embodiment.

### DETAILED DESCRIPTION

Hereinafter, with reference to the drawings, an embodiment of a heating cooker according to the present disclosure will be described. Note that, in the drawings, the same or corresponding portions are denoted by the same reference numerals, and descriptions thereof will not be repeated.

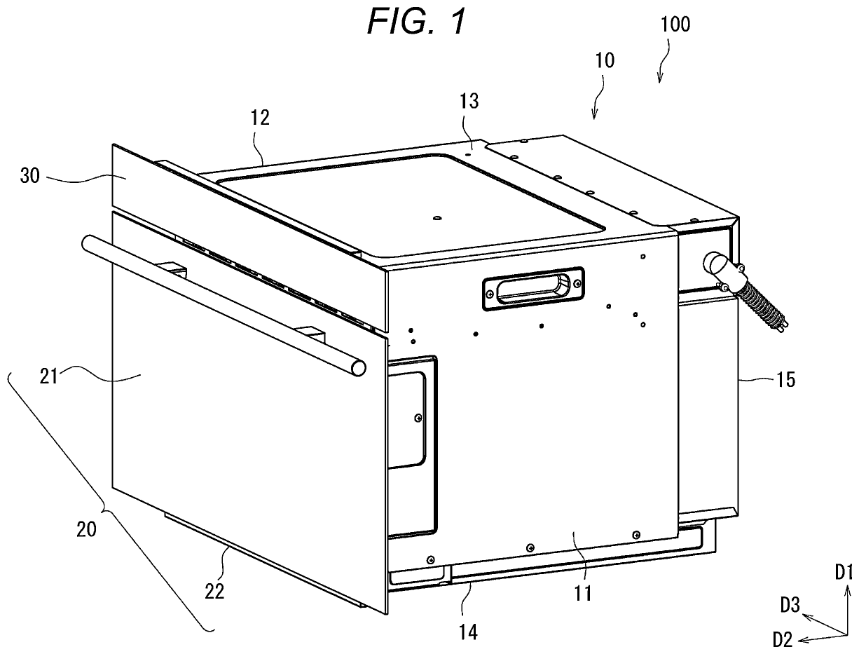

With reference to FIG. 1, a heating cooker 100 according to the embodiment will be described. FIG. 1 is a perspective view illustrating the heating cooker 100. In addition, FIG. 1 illustrates the external appearance of the heating cooker 100 when viewed diagonally from the upper right front. As illustrated in FIG. 1, the heating cooker 100 heats and cooks a heating-target object. The heating-target object is, for example, a food item. The heating cooker 100 includes a housing 10, a door 20, and an operation panel 30.

The operation panel 30 is a substantially rectangular plate-shaped member. The operation panel 30 receives an operation from a user. The operation includes, for example, a cooking method for heating and cooking a heating-target object. Specifically, the operation panel 30 includes a display unit. The display unit displays various items of information. Specifically, the display unit includes a liquid crystal panel.

In the embodiment, a side of the heating cooker 100 on which the operation panel 30 is disposed is defined as a front side of the heating cooker 100, and a side (back surface side) opposite to the front side is defined as a rear side of the heating cooker 100. In addition, when the heating cooker 100 is viewed from the front side, a right side is defined as a right side of the heating cooker 100, and a side opposite to the right side is defined as a left side of the heating cooker 100. In addition, in a direction orthogonal to a front-rear direction and a left-right direction of the heating cooker 100, a side on which the operation panel 30 is disposed is defined as an upper side of the heating cooker 100, and a side (bottom side) opposite to the upper side is defined as a lower side of the heating cooker 100. Note that, these directions and sides are not intended to limit directions and sides when the heating cooker 100 of the present disclosure is used. In the embodiment, a first direction D1 is an upward direction. A second direction D2 is a forward direction. A third direction D3 is a left direction.

The housing 10 is a box-shaped member. Specifically, the housing 10 has a right outer wall 11, a left outer wall 12, an upper outer wall 13, a lower outer wall 14, a rear outer wall 15, and a front wall 60 to be described below. The rear outer wall 15 intersects the second direction D2. The right outer wall 11 and the left outer wall 12 face each other in the third direction D3. The upper outer wall 13 and the lower outer wall 14 face each other in the first direction D1. The housing 10 accommodates the heating cooking compartment 50 to be described below.

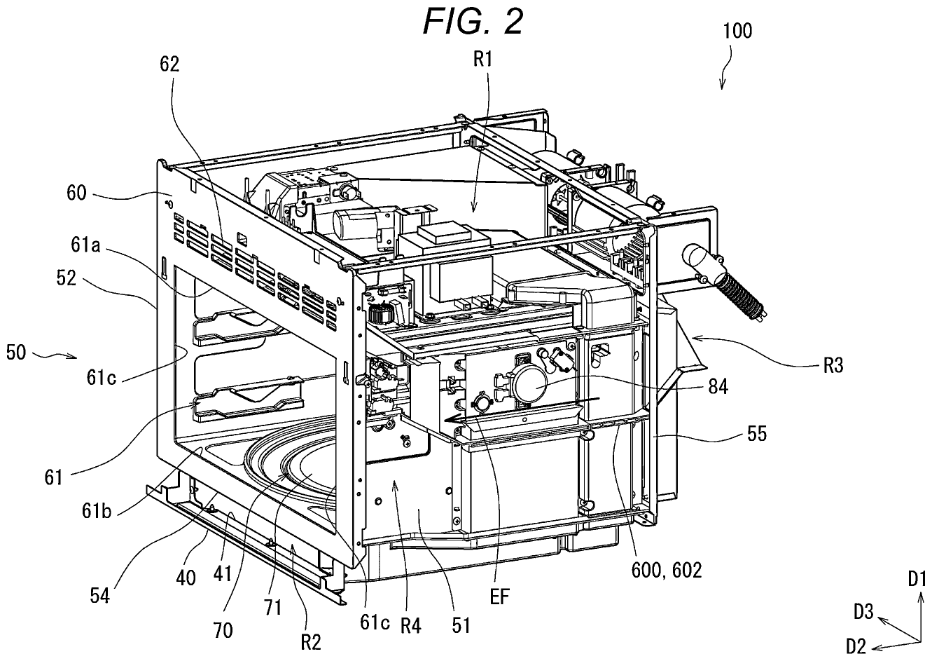

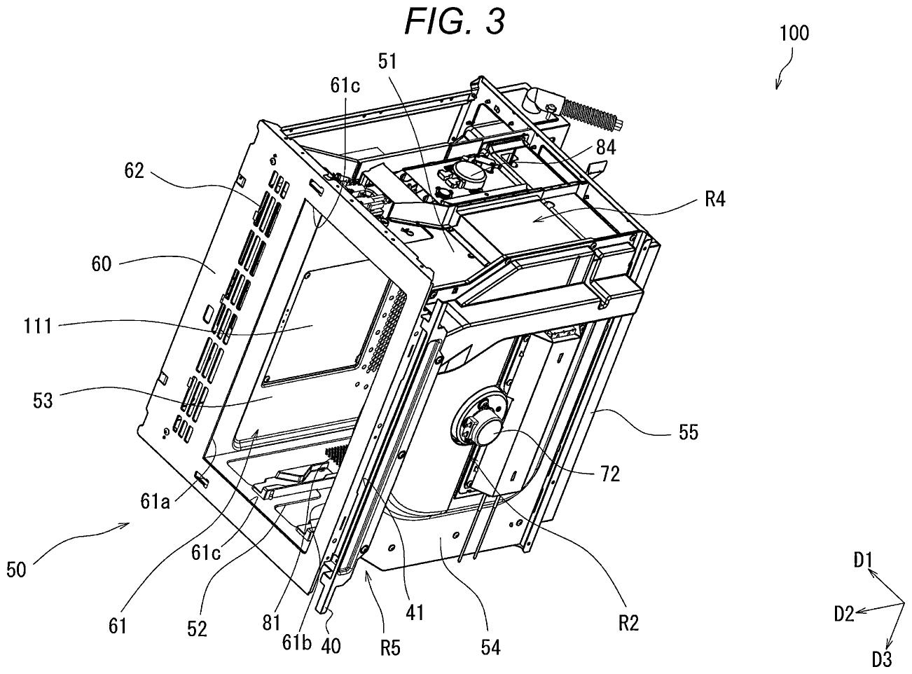

Continuing, a heating cooking compartment 50 will be described with reference to FIGS. 1 to 3. FIGS. 2 and 3 are perspective views illustrating the heating cooker 100 from which the housing 10 has been removed. FIG. 2 illustrates the external appearance of the heating cooker 100 when viewed diagonally from the upper right front. FIG. 3 illustrates the external appearance of the heating cooker 100 when viewed diagonally from the lower right front. As illustrated in FIGS. 2 and 3, the heating cooker 100 further includes the heating cooking compartment 50 and a placement portion 70.

The heating cooking compartment 50 allows a heating-target object to be accommodated therein. The heating cooking compartment 50 is accommodated in the housing 10. The heating cooking compartment 50 has, for example, a substantially rectangular parallelepiped shape. Specifically, the heating cooking compartment 50 has a right wall 51, a left wall 52, an upper wall 53, a lower wall 54, and a rear wall 55. The rear wall 55 intersects the second direction D2. The right wall 51 and the left wall 52 face each other in the third direction D3. The upper wall 53 and the lower wall 54 face each other in the first direction D1.

As illustrated in FIG. 3, the upper wall 53 constitutes at least a part of the heating cooking compartment 50. The upper wall 53 corresponds to, for example, a “wall portion”. The right wall 51 and the left wall 52 correspond to, for example, “side walls”. A material of each of the right wall 51, the left wall 52, the upper wall 53, the lower wall 54, and the rear wall 55 is, for example, stainless steel. Note that the material of each wall is not limited to stainless steel. Any metal having at least predetermined heat resistance and reflectance characteristics enabling the metal to reflect light may be used.

The placement portion 70 is a dish-shaped member. The placement portion 70 is accommodated in the heating cooking compartment 50. The placement portion 70 is configured to allow the heating-target object to be placed. As illustrated in FIGS. 2 and 3, the placement portion 70 includes a table 71 and a drive motor 72. The placement portion 70 is rotatable about a rotation axis in the first direction D1.

The heating-target object is placed on the table 71. The table 71 is disposed at the center of the lower wall 54.

The drive motor 72 rotates the table 71. To be specific, the drive motor 72 rotates the table 71 about a rotation axis in the first direction D1. The drive motor 72 is disposed below the heating cooking compartment 50.

The heating cooker 100 further includes a first space R1, a second space R2, a third space R3, a fourth space R4, and a fifth space R5. The first space R1 is disposed between the upper outer wall 13 and the upper wall 53. The second space R2 is disposed between the lower outer wall 14 and the lower wall 54. The third space R3 is disposed between the rear outer wall 15 and the rear wall 55. The fourth space R4 is disposed between the right outer wall 11 and the right wall 51. The fifth space R5 is disposed between the left outer wall 12 and the left wall 52.

The front wall 60 is a plate-shaped member having a quadrangular shape. The front wall 60 faces the rear wall 55. In addition, the front wall 60 faces the rear outer wall 15. The front wall 60 has an opening 61 and suction ports 62. The opening 61 allows an inside and an outside of the heating cooking compartment 50 to communicate with each other. In other words, the heating cooking compartment 50 has the opening 61 through which the heating-target object passes.

A front end portion of the upper wall 53 constitutes an upper side 61a of the opening 61. A front end portion of the lower wall 54 constitutes a lower side 61b of the opening 61 and faces the upper wall 53. Front end portions of the right wall 51 and the left wall 52 constitute sides 61c of the opening 61. The right wall 51 and the left wall 52 face each other with the upper wall 53 and the lower wall 54 interposed therebetween. The rear wall 55 faces the opening 61.

A plurality of suction ports 62 are disposed above the opening 61. Each of the plurality of suction ports 62 allows an inside and an outside of the first space R1 to communicate with each other. The plurality of suction ports 62 form eight columns. In each of the eight columns of the suction ports 62, three suction ports 62 are arranged in a column in an up-down direction.

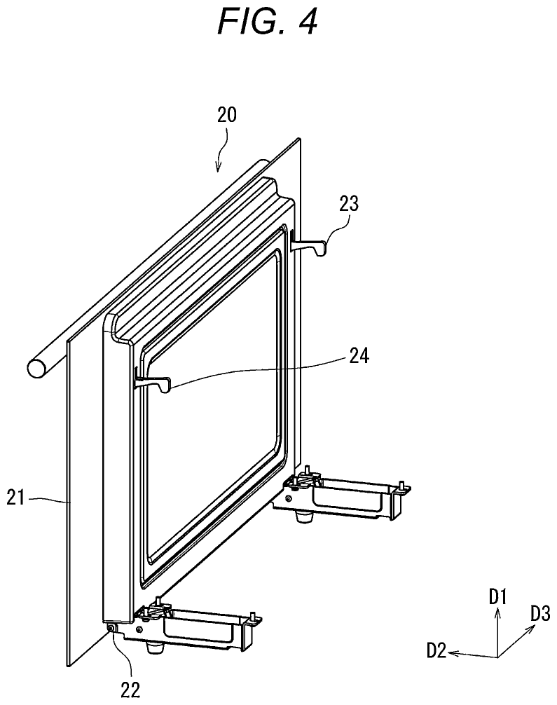

Continuing, the door 20 will be described with reference to FIGS. 1 to 4. FIG. 4 is a perspective view illustrating the door 20. The door 20 opens and closes the opening 61. As illustrated in FIGS. 1 to 4, the door 20 includes a substantially rectangular plate-shaped member 21 and a rotary shaft unit 22.

The rotary shaft unit 22 is positioned below the plate-shaped member 21. The plate-shaped member 21 opens and closes the opening 61. Specifically, the plate-shaped member 21 rotates about a rotation axis in the third direction D3. The plate-shaped member 21 opens the opening 61 in a state of being orthogonal to the first direction D1. On the other hand, the plate-shaped member 21 closes the opening 61 in a state of being orthogonal to the second direction D2.

To be specific, the door 20 includes a first connection member 23 and a second connection member 24. Both the first connection member 23 and the second connection member 24 connect the heating cooking compartment 50 and the door 20 when the door 20 is positioned at a closed position.

The first connection member 23 and the second connection member 24 are attached to the plate-shaped member 21. The first connection member 23 and the second connection member 24 face each other in the left-right direction. The first connection member 23 is attached to a left edge portion of a rear surface of the plate-shaped member 21. The second connection member 24 is attached to a right edge portion of the rear surface of the plate-shaped member 21.

For example, each of the first connection member 23 and the second connection member 24 has a hook member. The hook member is a plate-shaped member having a longitudinal direction thereof in the front-rear direction. The hook member includes a claw portion and a rotation pin portion. The rotation pin portion is positioned at one end portion of the hook member. The rotation pin portion rotates about a rotation axis extending in the third direction D3. On the other hand, the claw portion has a projecting portion projecting downward. The claw portion is positioned at the other end portion of the hook member. As a result, the claw portion is rotatable around the rotation pin portion. The claw portion can engage with a hole formed in the front wall 60.

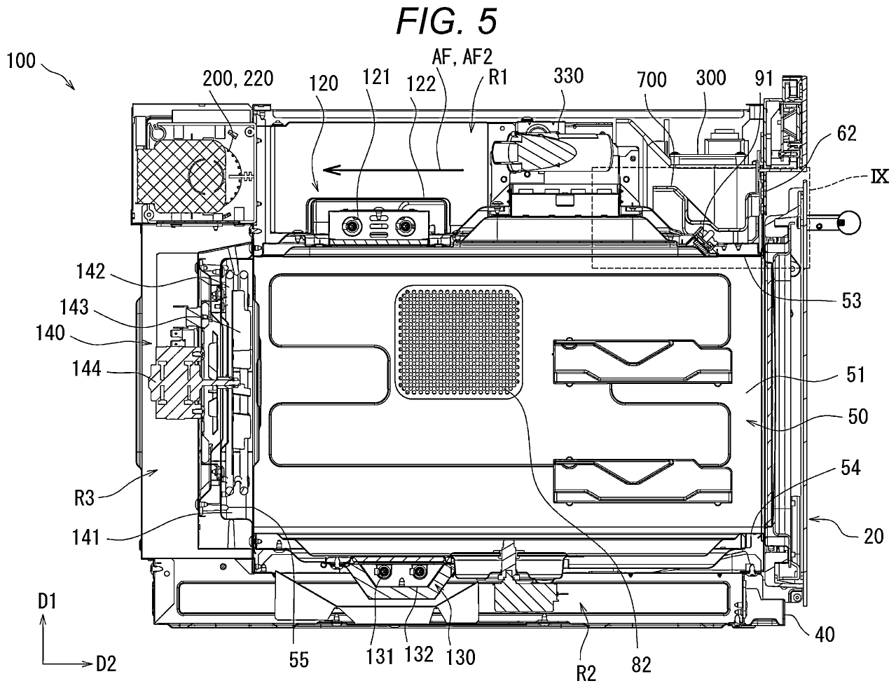

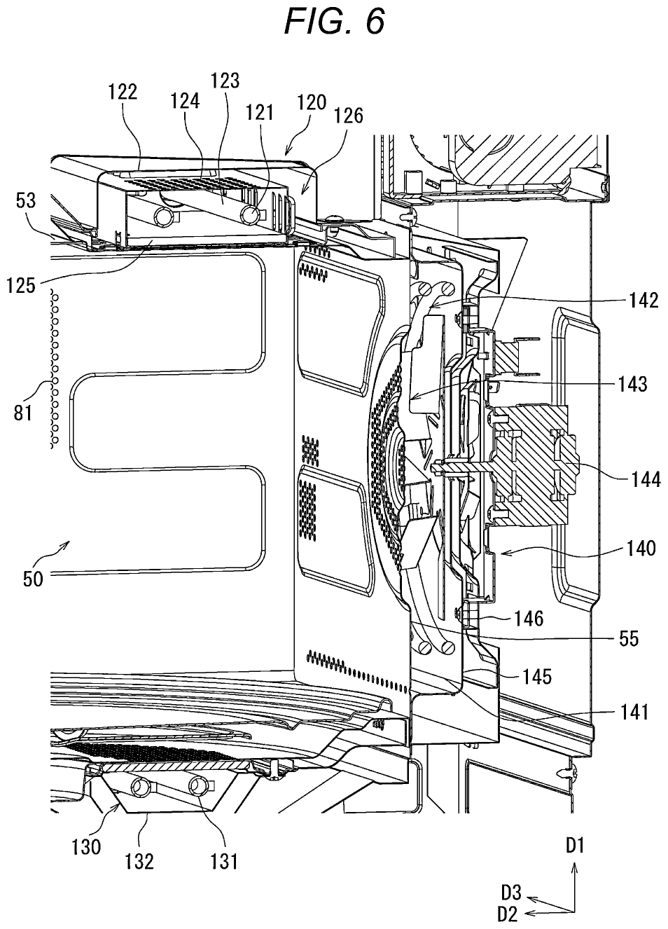

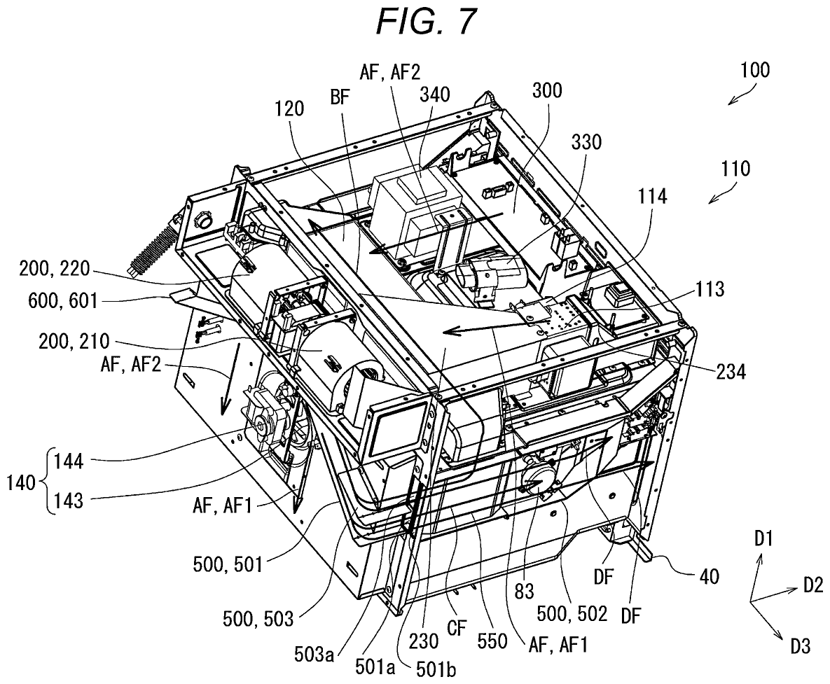

Next, the heating cooker 100 will be further described with reference to FIGS. 5 to 7. FIG. 5 is a view illustrating a schematic cross section of the heating cooker 100. To be specific, FIG. 5 is a cross-sectional view illustrating the heating cooker 100 cut along a plane orthogonal to the third direction D3. In addition, FIG. 6 is a view illustrating a schematic cross section of an air blower 140 according to the embodiment. Further, FIG. 7 is a perspective view illustrating the heating cooker 100 in a state where the housing 10 except for the front wall 60 thereof is removed. To be specific, FIG. 7 illustrates the external appearance of the heating cooker 100 when viewed diagonally from the upper left rear.

The heating cooker 100 further includes a discharge unit 40. As illustrated in FIGS. 2, 3, and 5, the discharge unit 40 partitions the second space R2 into an inside and an outside thereof. The discharge unit 40 is a plate-shaped member having a crank cross sectional shape. A lower portion of the discharge unit 40 is bent toward the front side. A length of the discharge unit 40 in the left-right direction is set to be substantially the same as a length of the lower wall 54 in the left-right direction. A front end of the discharge unit 40 is positioned behind a front end of the door 20.

The discharge unit 40 is disposed below the opening 61. An upper portion of the discharge unit 40 is fixed to a lower surface of the lower wall 54. As illustrated in FIGS. 2 and 3, the discharge unit 40 forms discharge ports 41 in cooperation with the front wall 60.

As illustrated in FIGS. 5 to 7, the heating cooker 100 includes a microwave supply unit 110, a first heater unit 120, a second heater unit 130, and the air blower 140. Each of the microwave supply unit 110, the first heater unit 120, the second heater unit 130, and the air blower 140 heats the heating-target object.

First, the microwave supply unit 110 will be described. The microwave supply unit 110 supplies microwaves into the heating cooking compartment 50.

The microwave supply unit 110 is disposed on the upper wall 53 of the heating cooking compartment 50. Specifically, the microwave supply unit 110 is positioned above the heating cooking compartment 50 with the upper wall 53 interposed therebetween. As illustrated in FIGS. 3 and 7, the microwave supply unit 110 includes a partition member 111, a radiation chamber, a magnetron 113, and a waveguide 114.

The magnetron 113 is disposed closer to the front wall 60 than the first heater unit 120. The magnetron 113 generates microwaves. The waveguide 114 propagates microwaves generated by the magnetron 113 to the radiation chamber.

As illustrated in FIG. 3, the partition member 111 is disposed between the radiation chamber and the upper wall 53 of the heating cooking compartment 50. Examples of a material of the partition member 111 are non-metals, and include a ceramic or mica. As a result, since the material of the partition member 111 contains a ceramic or mica, the partition member 111 transmits microwaves. On the other hand, materials of the radiation chamber and the waveguide 114 include metals.

Next, the first heater unit 120 will be described. As illustrated in FIG. 5, the first heater unit 120 is disposed above the heating cooking compartment 50. Specifically, the first heater unit 120 is disposed on the upper wall 53 of the heating cooking compartment 50. The first heater unit 120 includes a first heater 121, a thermal shield plate 122, a first tube 123, a heat reflection plate 124, and a glass plate 125.

The first heater 121 is, for example, a carbon heater. The first heater 121 in the state of power application generates heat. As a result, since the temperature rises quickly, the heating-target object can be cooked in a short time.

The thermal shield plate 122 shields heat. The thermal shield plate 122 covers an upper side, a front side, and a rear side of the heat reflection plate 124. The thermal shield plate 122 is made of a material including metal.

The first tube 123 is made of glass. The first tube 123 accommodates the first heater 121. The first tube 123 extends in the third direction D3.

The heat reflection plate 124 covers an upper side, a front side, and a rear side of the first heater 121. The heat reflection plate 124 reflects heat toward the heating cooking compartment 50. An air layer 126 is provided between the heat reflection plate 124 and the thermal shield plate 122.

The glass plate 125 is a substantially rectangular plate-shaped member. The glass plate 125 is disposed between a lower side of the first tube 123 and the heating cooking compartment 50. In other words, the glass plate 125 separates the first tube 123 from the heating cooking compartment 50. As a result, the glass plate 125 transmits heat rays from the first heater 121 to the heating cooking compartment 50. On the other hand, the glass plate 125 prevents moisture and salt from moving from the heating cooking compartment 50 to the first tube 123. Accordingly, a devitrification phenomenon of the first tube 123 can be prevented.

Next, the second heater unit 130 will be described. As illustrated in FIG. 5, the second heater unit 130 is disposed on the lower wall 54 of the heating cooking compartment 50. The second heater unit 130 includes a second heater 131 and a second heater case 132. The second heater 131 is, for example, a nichrome wire. The second heater 131 in the state of power application generates heat. An output of the second heater 131 is lower than an output of the first heater 121. The second heater case 132 covers a lower side, a front side, and a rear side of the second heater 131. The second heater case 132 is made of a material including metal. The second heater 131 in the state of power application generates heat.

Next, the air blower 140 will be described. The air blower 140 is configured to supply hot air into the heating cooking compartment 50. The air blower 140 is disposed in the third space R3. Specifically, the air blower 140 is positioned behind the heating cooking compartment 50 with the rear wall 55 interposed therebetween.

As illustrated in FIGS. 5 to 7, the air blower 140 includes an air blowing chamber 141, a third heater 142, a centrifugal fan 143, a drive unit 144, a partition member 145, and a heat shield plate 146. The air blowing chamber 141 is, for example, a box-shaped member made of metal. The centrifugal fan 143 has a plurality of blades.

The third heater 142 and the centrifugal fan 143 are accommodated in the air blowing chamber 141. The third heater 142 heats air inside the air blowing chamber 141 to generate hot air. Specifically, the third heater 142 has an annular shape when viewed from the front side toward the rear side. The third heater 142 is disposed along an outer circumference of the centrifugal fan 143.

As illustrated in FIG. 6, the rear wall 55 has a suction hole portion and a blow-out hole portion. To be specific, the suction hole portion is, for example, a group of a plurality of punched holes. Similarly, the blow-out hole portion is also, for example, a group of a plurality of punched holes. A punched hole has, for example, a circular shape. A diameter of a punched hole of each of the suction hole portion and the blow-out hole portion is, for example, 3 mm or larger and 4 mm or smaller in order to prevent microwaves from leaking from the inside of the heating cooking compartment 50. The diameter is preferably 3.4 mm.

The partition member 145 is, for example, a plate-shaped member made of metal. The partition member 145 has, for example, an oblong shape when viewed from the front side toward the rear side. The partition member 145 is disposed on substantially the entire surface of the rear wall 55. Specifically, the partition member 145 is positioned on the outward side from the rear wall 55.

The heat shield plate 146 is, for example, a plate-shaped member made of metal. The heat shield plate 146 is, for example, a plate-shaped member having a quadrangular shape when viewed from the front side toward the rear side. The heat shield plate 146 is positioned on the outward side from the partition member 145.

The drive unit 144 is positioned an outward side from the air blowing chamber 141. Specifically, the drive unit 144 is positioned on an outward side from the heat shield plate 146, and a shaft portion of the drive unit 144 penetrates the partition member 145 and the heat shield plate 146 and is connected to the centrifugal fan 143. The drive unit 144 drives the centrifugal fan 143. The drive unit 144 includes, for example, a motor.

The air blower 140 draws in hot air in the heating cooking compartment 50 through the suction hole portion, and blows hot air into the heating cooking compartment 50 through the blow-out hole portion. To be more specific, the air blower 140 draws in hot air from a central portion inside the heating cooking compartment 50 and blows the hot air to a peripheral border portion inside the heating cooking compartment 50. As a result, the entire inside of the heating cooking compartment 50 can be heated by driving the air blower 140.

As illustrated in FIGS. 2, 3, 5, and 7 again, the heating cooking compartment 50 further includes the intake hole portion 81, the exhaust hole portion 82, the intake damper unit 83, and the exhaust damper unit 84.

The intake hole portion 81 allows the inside and the outside of the heating cooking compartment 50 to communicate with each other. Specifically, the intake hole portion 81 is disposed on the left wall 52. The intake hole portion 81 has, for example, a quadrangular shape. Specifically, the intake hole portion 81 includes, for example, a plurality of punched holes. A punched hole has, for example, a circular shape. A diameter of a punched hole of the intake hole portion 81 is, for example, 3 mm or larger and 4 mm or smaller in order to prevent microwaves from leaking. The diameter is preferably 3.4 mm.

The intake damper unit 83 opens and closes the intake hole portion 81. The intake damper unit 83 is attached to an outer side of the left wall 52. For example, in a case where the intake damper unit 83 opens the intake hole portion 81, the inside and the outside of the heating cooking compartment 50 communicate with each other. As a result, air is guided to the intake hole portion 81. On the other hand, in a case where the intake damper unit 83 closes the intake hole portion 81, the inside and the outside of the heating cooking compartment 50 do not communicate with each other. As a result, air is not guided to the intake hole portion 81.

In addition, the exhaust hole portion 82 allows the inside and the outside of the heating cooking compartment 50 to communicate with each other. Specifically, the exhaust hole portion 82 is disposed on the right wall 51. The exhaust hole portion 82 has, for example, a quadrangular shape. Specifically, the exhaust hole portion 82 includes, for example, a plurality of punched holes. A punched hole has, for example, a circular shape. A diameter of a punched hole of the exhaust hole portion 82 is, for example, 3 mm or larger and 4 mm or smaller in order to prevent microwaves from leaking. The diameter is preferably 3.4 mm.

The exhaust damper unit 84 opens and closes the exhaust hole portion 82. The exhaust damper unit 84 is attached to an outer side of the right wall 51. For example, in a case where the exhaust damper unit 84 opens the exhaust hole portion 82, the inside and the outside of the heating cooking compartment 50 communicate with each other. On the other hand, in a case where the exhaust damper unit 84 closes the exhaust hole portion 82, the inside and the outside of the heating cooking compartment 50 do not communicate with each other.

A flow of air inside the heating cooking compartment 50 will be described. First, the intake damper unit 83 opens the intake hole portion 81, and the exhaust damper unit 84 opens the exhaust hole portion 82. As a result, air is guided to the intake hole portion 81. The air is blown into the heating cooking compartment 50 through the intake hole portion 81. The air blown from the intake hole portion 81 moves into the heating cooking compartment 50 in a direction opposite to the third direction D3. Thereafter, the air is discharged from the exhaust hole portion 82 to the outside of the heating cooking compartment 50. The air performs scavenging of steam or the like in the heating cooking compartment 50.

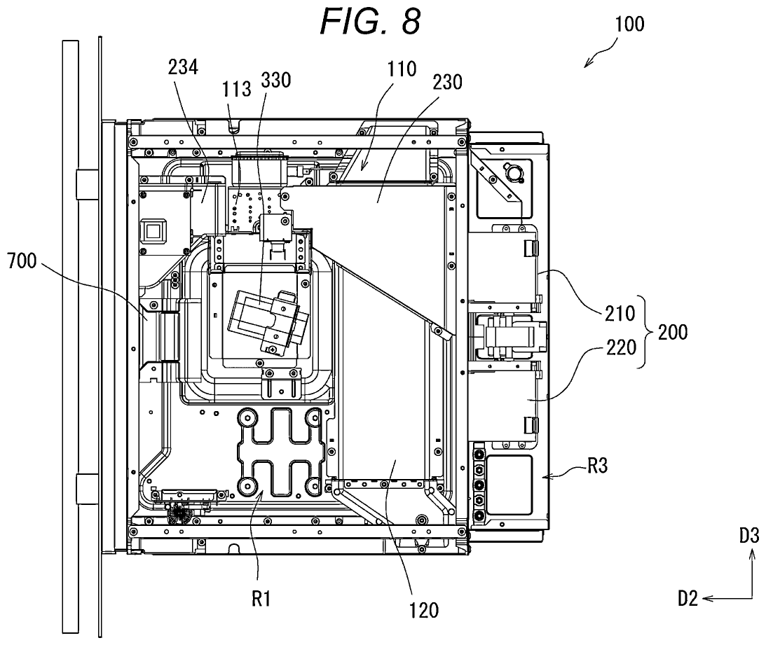

Next, the heating cooker 100 will be further described with reference to FIGS. 2, 5, 7, and 8. FIG. 8 is a plan view illustrating the heating cooker 100 in a state where the housing 10 and a control board 300 are removed according to the embodiment.

As illustrated in FIGS. 2 and 7, the heating cooker 100 includes a cooling fan 200, a first wind direction plate 500, a first guide unit 550, and a second wind direction plate 600.

The cooling fan 200 generates an air flow. As illustrated in FIGS. 2, 5, and 7, the cooling fan 200 generates a first air flow AF, a second air flow BF, a third air flow CF, a fourth air flow DF, and a fifth air flow EF. The second air flow BF, the third air flow CF, the fourth air flow DF, and the fifth air flow EF are branches from the first air flow AF.

The first air flow AF mainly cools the drive motor 72 and the drive unit 144. The second air flow BF mainly cools the first heater unit 120. The third air flow CF mainly performs scavenging of the inside of the heating cooking compartment 50. The fourth air flow DF mainly cools a motor of the intake damper unit 83. The fifth air flow EF mainly cools a motor of the exhaust damper unit 84.

For example, the cooling fan 200 is a Sirocco fan. As illustrated in FIGS. 7 and 8, the cooling fan 200 is disposed between the rear wall 55 of the heating cooking compartment 50 and the rear outer wall 15 of the housing 10. Specifically, the cooling fan 200 is disposed in a region in which the first space R1 and the third space R3 overlap each other. The cooling fan 200 is disposed between the heating cooking compartment 50 and the housing 10, and suctions air from the suction port 62 to a space between the heating cooking compartment 50 and the housing 10. The cooling fan 200 includes a left fan portion 210 and a right fan portion 220.

The left fan portion 210 supplies cooling air to a left region of the cooling fan 200 to generate a left-side first air flow AF1 that is a part of the first air flow AF. The left fan portion 210 is positioned at the same height as the plurality of suction ports 62. The left fan portion 210 generates the left-side first air flow AF1 between the upper wall 53 of the heating cooking compartment 50 and the upper outer wall 13 of the housing 10. The left fan portion 210 takes air outside the heating cooker 100 into the first space R1. In addition, the left fan portion 210 generates the left-side first air flow AF1 between the rear wall 55 of the heating cooking compartment 50 and the rear outer wall 15 of the housing 10. The left fan portion 210 discharges the air in the first space R1 into the third space R3.

As illustrated in FIG. 5, the right fan portion 220 is positioned at the same height as the plurality of suction ports 62. The right fan portion 220 generates a right-side first air flow AF2 between the upper wall 53 of the heating cooking compartment 50 and the upper outer wall 13 of the housing 10, the right-side first air flow AF2 being a part of the first air flow AF. The right fan portion 220 takes air outside the heating cooker 100 into the first space R1. In addition, the right fan portion 220 generates the right-side first air flow AF2 between the rear wall 55 of the heating cooking compartment 50 and the rear outer wall 15 of the housing 10. The right fan portion 220 discharges the air in the first space R1 into the third space R3. The left-side first air flow AF1 and the right-side first air flow AF2 are joined downstream of the cooling fan 200 (third space R3) to generate the first air flow AF.

As illustrated in FIG. 7, the first wind direction plate 500 includes a first skew plate 501, a second skew plate 503, and a horizontal plate 502.

The first skew plate 501 guides the third air flow CF to the suction port 501a of the intake damper unit 83. The third air flow CF is a part of the left-side first air flow AF1 flowing along the first skew plate 501. The first skew plate 501 guides the fourth air flow DF to the suction port 501b directed to the left wall 52. The fourth air flow DF is a remaining part of the left-side first air flow AF1 flowing along the first skew plate 501. Specifically, the first skew plate 501 is disposed on the heat shield plate 146. The first skew plate 501 is provided upright on the heat shield plate 146. The first skew plate 501 extends from below the left fan portion 210 toward the left wall 52.

The second skew plate 503 guides the second air flow BF to the suction port 503a of the first heater unit 120. The second air flow BF is a part of the left-side first air flow AF1 flowing along the second skew plate 503. The second skew plate 503 guides the fourth air flow DF to the suction port 501b directed to the left wall 52. The fourth air flow DF is the remaining part of the left-side first air flow AF1 flowing along the second skew plate 503. That is, the fourth air flow DF includes the remaining part of the left-side first air flow AF1 flowing along the first skew plate 501 and the remaining part of the left-side first air flow AF1 flowing along the second skew plate 503. The second skew plate 503 is disposed on the heat shield plate 146. The second skew plate 503 is provided upright on the heat shield plate 146. The second skew plate 503 is positioned on the upper side from the first skew plate 501. The second skew plate 503 extends from below the left fan portion 210 toward the left wall 52.

The horizontal plate 502 is disposed on the left wall 52. The horizontal plate 502 is provided upright on the left wall 52. The horizontal plate 502 passes below the intake damper unit 83 from the rear wall 55 and extends toward the front wall 60.

The first guide unit 550 guides the second air flow BF from the left fan portion 210 to the first heater unit 120. Specifically, the first guide unit 550 is a cylindrical body. The cylindrical body has the suction port 503a and a blow-out port. The cylindrical body is disposed on the left wall 52. The suction port 503a is open in the direction opposite to the second direction D2. The blow-out port is open toward the first heater unit 120 and the intake hole portion 81.

As illustrated in FIGS. 2 and 7, the second wind direction plate 600 includes a skew plate 601 and a horizontal plate 602.

The skew plate 601 guides the fifth air flow EF to the exhaust damper unit 84. The fifth air flow EF is a part of the right-side first air flow AF2. The skew plate 601 is disposed on the heat shield plate 146. The skew plate 601 is provided upright on the heat shield plate 146. The skew plate 601 extends from below the right fan portion 220 toward the right wall 51.

The horizontal plate 602 is disposed on the right wall 51. The horizontal plate 602 is provided upright on the right wall 51. The horizontal plate 602 passes below the exhaust damper unit 84 from the rear wall 55 and extends toward the front wall 60.

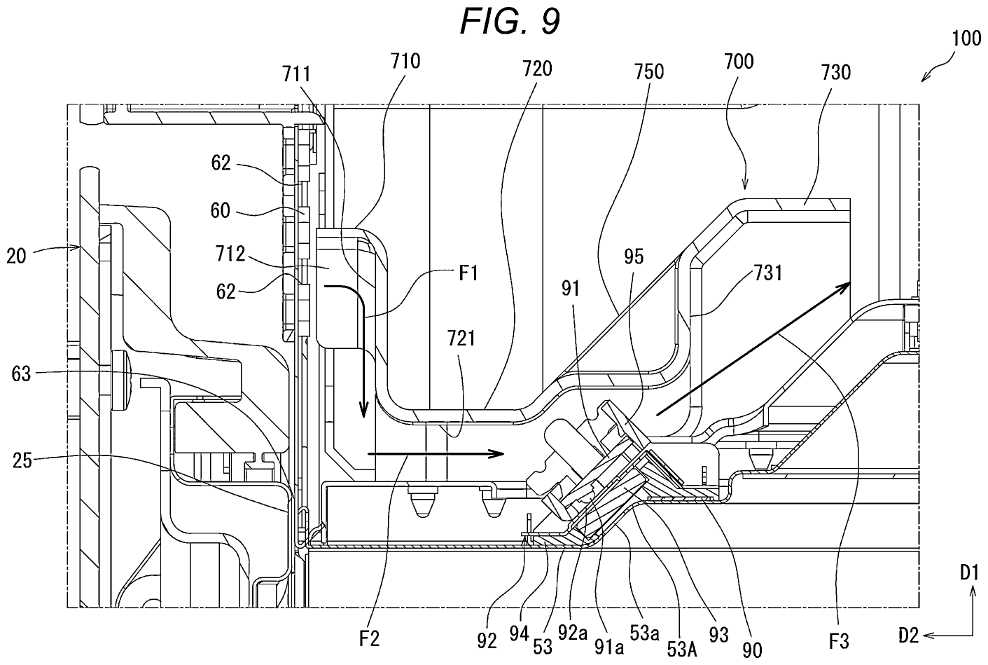

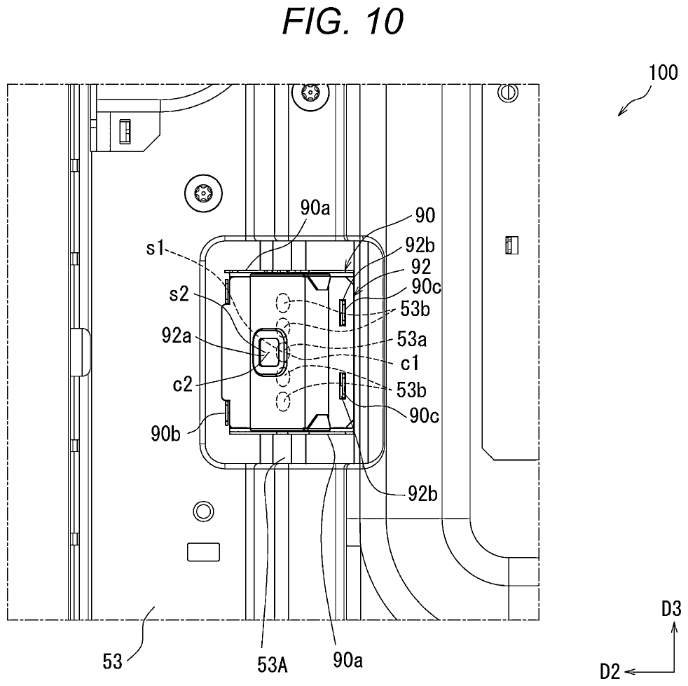

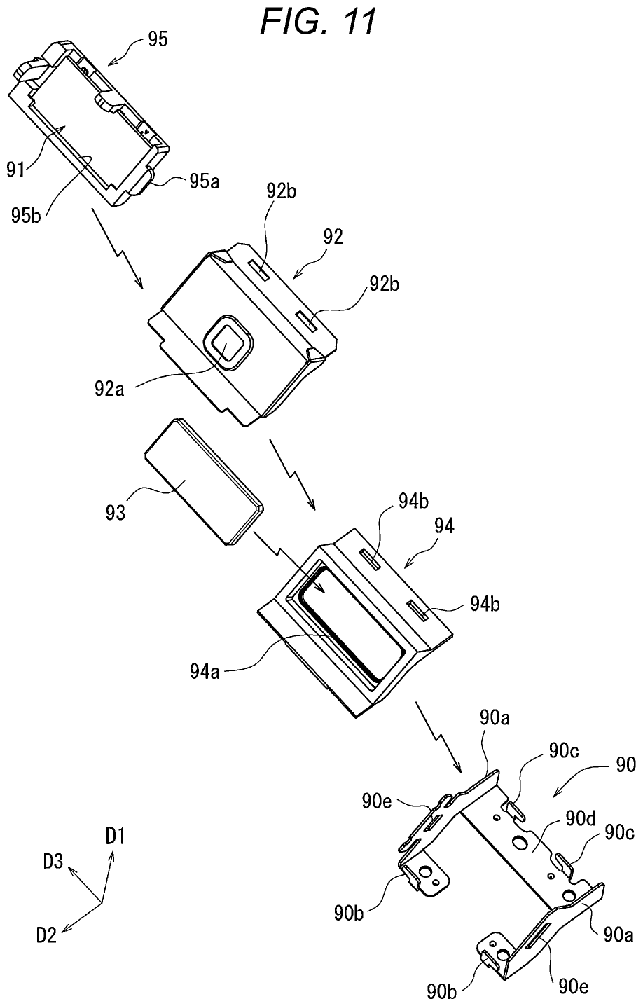

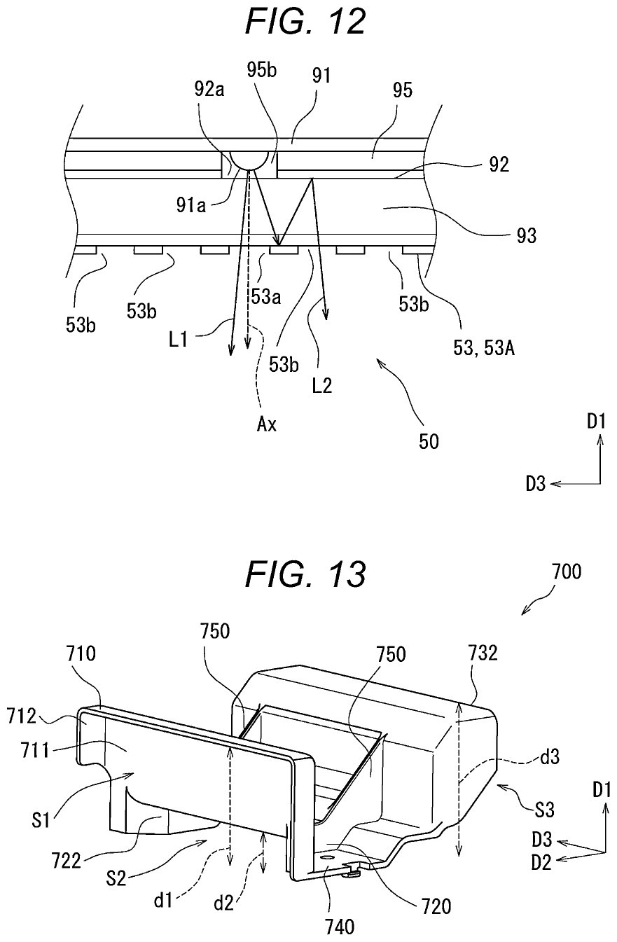

Next, the heating cooker 100 will be further described with reference to FIGS. 5 and 8 to 12. FIG. 9 is an enlarged view of a region IX in FIG. 5. FIG. 10 is a plan view illustrating a part of the upper wall 53 in a state where the irradiator 91 and a holder 95 are removed according to the embodiment. FIG. 11 is an exploded perspective view illustrating a mounting structure of the irradiator 91. FIG. 12 is a descriptive view for illustrating a traveling path of irradiation light.

As illustrated in FIGS. 9 to 12, the heating cooker 100 includes a mounter 90, an irradiator 91, a reflector 92, a glass portion 93, packing 94, and the holder 95.

The irradiator 91 emits light. The irradiator 91 is an interior lighting that irradiates an inside of the heating cooking compartment 50 through a first opening 53a and a second opening 53b to be described below. As illustrated in FIGS. 5, 9, and 12, the irradiator 91 is disposed on an outer side of the heating cooking compartment 50 with respect to the upper wall 53 and irradiates the inside of the heating cooking compartment 50 with light from an outside of the heating cooking compartment. The irradiator 91 includes a light-emitting element (LED) 91a. The light-emitting element 91a is a light emitting diode, a laser diode, or the like. The irradiator 91 only has to be at least an irradiation device capable of emitting light.

As illustrated in FIGS. 9 and 10, the mounter 90 is fixed to the upper wall 53. The mounter 90 positions the irradiator 91 on the upper wall 53. As illustrated in FIG. 11, the mounter 90 includes a first restriction portion 90a, a second restriction portion 90b, and a third restriction portion 90c.

For example, a pair of right and left first restriction portions 90a is provided. The pair of first restriction portions 90a stands in the first direction D1 in a state of facing each other in the third direction D3. The pair of first restriction portions 90a is connected by a connection portion 90d. The irradiator 91 is sandwiched and positioned between the pair of first restriction portions 90a. The first restriction portion 90a has a first restriction hole 90e that supports the holder 95. The second restriction portion 90b stands in the first direction D1 in a state of being orthogonal to the second direction D2. The second restriction portion 90b restricts the movement of the reflector 92 and the packing 94 in the second direction D2. The third restriction portion 90c stands in the first direction D1 from an end portion of the connection portion 90d on a side opposite to the second direction D2, in a state where the third restriction portion 90c is orthogonal to the second direction D2. The third restriction portion 90c restricts the movement of the reflector 92 and the packing 94 in the second direction D2 and the third direction D3. The packing 94, the reflector 92, and the holder 95 are disposed between the pair of first restriction portions 90a.

The packing 94 closes a space between an outer edge portion of the glass portion 93 and an inclined portion 53A. That is, the packing 94 can reduce hot air leaking from the inside of the heating cooking compartment 50 to the first space R1 through the first opening 53a and the second opening 53b. The glass portion 93 is not limited to a glass member. The glass portion 93 only needs to transmit at least light and block the first opening 53a and the second opening 53b. The glass portion 93 may be, for example, a transparent synthetic resin material.

The packing 94 has a glass support 94a and a packing mounting hole 94b. The glass support 94a has a rectangular penetration port, and the glass portion 93 closing the penetration port is supported at an edge portion of the penetration port. The packing mounting hole 94b is disposed at a position on the glass support 94a opposite to the second direction D2. The third restriction portion 90c is inserted into the packing mounting hole 94b. Displacement of the packing 94 in the left-right direction is restricted by the first restriction portion 90a, and displacement thereof in the front-rear direction is restricted by the third restriction portion 90c. An end portion of the packing 94 in the second direction D2 is brought into contact with the second restriction portion 90b. The reflector 92 is placed on an upper portion on which the glass portion 93 is mounted.

The reflector 92 reflects light. The reflector 92 is made of, for example, a stainless steel plate material. The reflector 92 is placed on the packing 94 with the glass portion 93 interposed therebetween, and the holder 95 to which the irradiator 91 is attached is placed.

As illustrated in FIG. 11, the holder 95 includes holder supports 95a and an irradiator mounting hole 95b.

The holder supports 95a project from both right and left end portions of the holder 95, and are inserted into the first restriction hole 90e of the first restriction portion 90a.

The irradiator mounting hole 95b has a rectangular penetration port, and the irradiator 91 is supported at an edge portion of the penetration port.

The reflector 92 has a configuration in which a surface thereof in a direction opposite to the first direction D1 reflects light. The light-emitting element 91a of the irradiator 91 is disposed corresponding to an opening 92a.

The reflector 92 has the opening 92a through which the light of the irradiator 91 passes, and a reflector mounting hole 92b provided at a position overlapping the packing mounting hole 94b.

The opening 92a of the reflector 92 is disposed to face the inclined portion 53A. That is, the irradiator 91 is disposed with respect to the inclined portion 53A. Consequently, the light emitted from the irradiator 91 reaches deep in the heating cooking compartment 50, so that the illumination performance in the heating cooking compartment 50 is increased.

The third restriction portion 90c is inserted into the reflector mounting hole 92b. Displacement of the reflector 92 in the left-right direction is restricted by the first restriction portion 90a, and displacement thereof in the front-rear direction is restricted by the third restriction portion 90c. An end portion of the reflector 92 in the second direction D2 is brought into contact with the second restriction portion 90b.

As illustrated in FIG. 12, the reflector 92 reflects light emitted from the irradiator 91. Specifically, the reflector 92 reflects light reflected from the glass portion 93 or the upper wall 53. The reflector 92 is disposed at a position on the upper wall 53 opposite to the heating cooking compartment 50.

The light emitted from the irradiator 91 is mainly reflected from the upper wall 53. Although the light is also reflected at a boundary surface between an upper side and a lower side of the glass portion 93, most (about 90%) of the light is transmitted and only a part of the light is reflected at the boundary surface of the glass portion 93, and thus, the illustration thereof is omitted. Hence, the reflector 92 mainly reflects the light reflected from the upper wall 53, but also reflects the light reflected from the boundary surface of the glass portion 93. In addition, the light travels while being refracted at the boundary surface of the glass portion 93, but is illustrated as light traveling without refraction in FIG. 12 for easy understanding.

As illustrated in FIGS. 9, 10, and 12, the upper wall 53 has an inclined portion 53A. The inclined portion 53A is provided along the upper side 61a (see FIG. 2) of the opening 61 and faces a direction from the opening 61 toward the rear wall 55 (see FIG. 2). Specifically, the inclined portion 53A extends in the third direction D3 and is disposed in a direction opposite to the second direction D2. The inclined portion 53A has a first opening 53a and a second opening 53b. The first opening 53a and the second opening 53b have, for example, an elliptical shape having a major axis in the third direction D3.

As illustrated in FIG. 12, the first opening 53a mainly allows light L1 emitted from the irradiator 91 to pass therethrough. The second opening 53b is provided to allow light L2 reflected from the reflector 92 to pass therethrough. Consequently, the amount of light with which the inside of the heating cooking compartment 50 is irradiated can be increased. Specifically, in addition to the first opening 53a through which the light L1 emitted from the irradiator 91 directly passes, the second opening 53b through which the light L2 reflected from the reflector 92 without passing through the first opening 53a passes is provided, so that light introduced into the heating cooking compartment 50 can be increased.

The first opening 53a is provided to allow the light L1 emitted from the irradiator 91 to directly pass through without reflecting the light L1. However, as a result of repeated reflection between the upper wall 53 and the reflector 92, a part of the reflected light may pass through the first opening 53a. On the other hand, the second opening 53b is provided to allow the light L2 reflected from the reflector 92 to pass therethrough. In the case of the second opening 53b close to the opening 92a, the light L1 may pass in addition to the light L2. In the embodiment, for easy understanding, an example in which only the light L1 passes through the first opening 53a and only the light L2 passes through the second opening 53b is described.

For example, the first opening 53a is provided at a center position of the inclined portion 53A in the third direction D3 to face the light-emitting element 91a of the irradiator 91. For example, a plurality of second openings 53b is provided with the first opening 53a interposed therebetween. As illustrated in FIGS. 10 and 12, specifically, the plurality of second openings 53b is arranged symmetrically with respect to each other with the first opening 53a interposed therebetween. The first opening 53a and the plurality of second openings 53b are disposed on the inclined portion 53A along the upper side 61a (see FIG. 2). A wall part between the first opening 53a and the second opening 53b and a wall part between the second opening 53b and an adjacent second opening 53b thereto are non-opening regions. A distance between the first opening 53a and the second opening 53b and a distance between the second opening 53b and the adjacent second opening 53b thereto are preferably as short as possible. For example, the shortest distance between the first opening 53a and the second opening 53b and the shortest distance between the second opening 53b and the adjacent second opening 53b thereto are preferably ½ or shorter of the shortest distance from the center of the first opening 53a or the center of the second opening 53b to the non-opening region. As a result, a shadow region in the heating cooking compartment 50 caused by the non-opening region can be decreased in size. Note that a separation distance between the first opening 53a and an adjacent second opening 53b thereto is the same as the separation distance between the second opening 53b and an adjacent second opening 53b thereto.

As illustrated in FIGS. 10 and 12, when viewed from an optical axis Ax corresponding to an irradiation direction of the irradiator 91, the first opening 53a is provided at a position which at least partially overlaps the opening 92a. Here, in order to allow the light L1 emitted from the irradiator 91 to directly pass without being reflected, it is preferable that a center c1 of the first opening 53a and a center c2 of the opening 92a coincide with each other when viewed from the optical axis Ax. In addition, an area s2 of the opening 92a is preferably equal to or larger than an area s1 of the first opening 53a.

The second opening 53b is provided at a position which does not overlap the opening 92a when viewed in a direction of the optical axis Ax of the irradiator 91. Note that the second opening 53b is not limited to being provided at the position which does not overlap with the opening 92a in the direction of the optical axis Ax. The second opening 53b may be provided at a position which partially overlaps the opening 92a in the direction of the optical axis Ax. In addition, in the direction of the optical axis Ax, both the second opening 53b at the position which partially overlaps the opening 92a and the second opening 53b at the position which does not overlap the opening 92a may be provided.

In a case where a pressure in a space where the irradiator 91 is installed is higher than that of the inside of the heating cooking compartment 50, hot air is less likely to leak from the inside of the heating cooking compartment 50 to the outside of the heating cooking compartment 50 (the space where the irradiator 91 is installed), so that it is not necessary to provide the glass portion 93. However, in a case where the cooling fan 200 is disposed downstream of the irradiator 91, the pressure in the space where irradiator 91 is installed is lower than that of the inside of the heating cooking compartment 50, so that hot air leaks from the inside of the heating cooking compartment 50 to the outside of the heating cooking compartment 50 (the space where the irradiator 91 is installed). Therefore, by providing the glass portion 93, leakage of hot air is reduced. However, when the glass portion 93 is provided, it is difficult to dispose the irradiator 91 near the first opening 53a, and the amount of light with which the inside of the heating cooking compartment 50 is irradiated is reduced. Thus, for example, in a case where it is difficult to dispose the irradiator 91 near the first opening 53a as in a case where the glass portion 93 is provided, light that does not directly pass through the first opening 53a can also be guided into the heating cooking compartment 50 by providing the second opening 53b and the reflector 92 in addition to the first opening 53a, so that the amount of light with which the inside of the heating cooking compartment 50 is irradiated can be increased.

As illustrated in FIG. 8, the heating cooker 100 includes the first heater unit 120 that heats the inside of the heating cooking compartment 50. The glass portion 93 reduces leakage of heat from the heating cooking compartment 50 through the first opening 53a and the second opening 53b. Diameters of the first opening 53a and the second opening 53b are set to a value of, for example, 3 mm or larger and 4 mm or smaller. Consequently, the first opening 53a and the second opening 53b reduce leakage of microwaves.

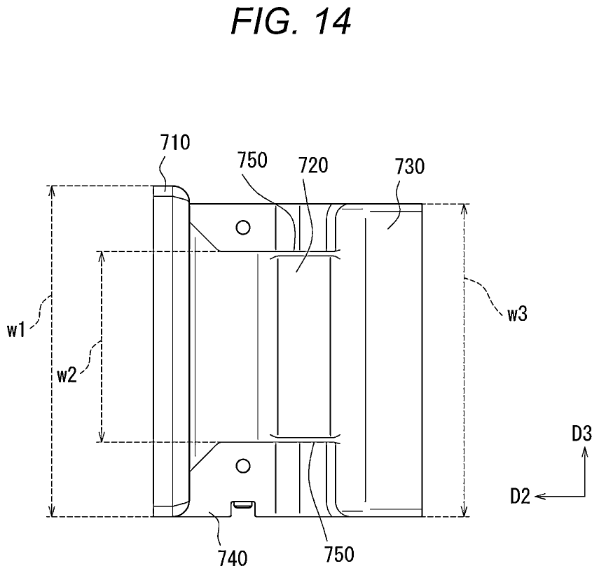

Next, the heating cooker 100 will be further described with reference to FIGS. 8, 9, 13, and 14. FIG. 13 is a perspective view illustrating a flow channel section 700 according to the embodiment. FIG. 14 is a plan view illustrating the flow channel section 700 according to the embodiment. To be specific, FIG. 13 illustrates the external appearance of the flow channel section 700 when viewed diagonally from the right front.

As illustrated in FIGS. 8, 9, 13, and 14, the heating cooker 100 includes the flow channel section 700. The flow channel section 700 introduces air which is suctioned by a negative pressure of the cooling fan 200 into the first space R1 from the suction ports 62. In the flow channel section 700, in cooperation with the upper wall 53, air which flows in a direction opposite to the second direction D2 from the suction ports 62 toward the cooling fan 200 and is introduced from the suction ports 62 flows.

The flow channel section 700 is made of, for example, a synthetic resin material. As illustrated in FIGS. 9, 13, and 14, the flow channel section 700 includes a first flow channel section 710, a second flow channel section 720, a third flow channel section 730, a flange 740, and a rib 750. The flange 740 fixes the flow channel section 700 to the upper wall 53 via a fixing member.

The first flow channel section 710 introduces air from the suction ports 62. When the door 20 is closed, a contact portion 25 of the door 20 and a contact portion 63 of the front wall 60 come into contact with each other. In the embodiment, the upper wall 53 is disposed corresponding to a height position at which the contact portion 25 and the contact portion 63 are in contact with each other. An upper end portion of the first flow channel section 710 is positioned between an upper end portion of the suction port 62 and a lower end portion of the suction port 62. The first flow channel section 710 includes a first guide portion 711 and a first flow channel opening 712.

The first guide portion 711 guides the air introduced from the suction ports 62 to the second flow channel section 720. Specifically, the first guide portion 711 extends downward from an upper end portion of the first flow channel section 710. A length d1 of the first flow channel section 710 in the first direction D1 is a length from an upper end to a lower end of the first flow channel section 710. A length w1 of the first flow channel section 710 in the third direction D3 is a length from a left end to a right end of the first flow channel section 710.

As illustrated in FIG. 9, the first flow channel opening 712 is connected to the suction port 62. The first flow channel opening 712 corresponds to an end portion of the first flow channel section 710 in the second direction D2. An opening area of the first flow channel opening 712 is the same as a first flow channel area S1. The first flow channel area S1 is a flow channel area of the first flow channel opening 712 orthogonal to the second direction D2. As illustrated in FIG. 9, the air suctioned with the negative pressure of the cooling fan 200 is introduced into the first space R1 from the suction ports 62 to form an air flow F1. The air flow F1 is guided downward by the first guide portion 711.

The second flow channel section 720 introduces air from the first flow channel section 710. The second flow channel section 720 is continuous with an end portion of the first flow channel section 710 in a direction opposite to the second direction D2. The second flow channel section 720 accommodates the irradiator 91 therein. The irradiator 91 is disposed at a position lower than the suction ports 62 and is disposed at a position lower than the cooling fan 200. As illustrated in FIGS. 9, 13, and 14, the second flow channel section 720 includes a second guide portion 721 and a second flow channel opening 722.

As illustrated in FIG. 9, the second guide portion 721 guides air introduced from the first flow channel section 710 to the third flow channel section 730. As illustrated in FIGS. 9, 13, and 14, the second guide portion 721 extends in parallel with the direction opposite to the second direction D2. Consequently, an air flow F2 in the direction opposite to the second direction D2 is formed.

An opening area of the second flow channel opening 722 is the same as a second flow channel area S2. The second flow channel area S2 is a flow channel area of the second flow channel opening 722 orthogonal to the second direction D2. The second flow channel area S2 is smaller than the first flow channel area S1. Since the irradiator 91 is disposed inside the second flow channel section 720, the irradiator 91 can be disposed in a region on a path of the air flow F2 formed by the cooling fan 200. Specifically, since the second flow channel section 720 has the second flow channel area S2 smaller than the first flow channel area S1 of the first flow channel opening 712, the air flow F1 flowing in the first flow channel section 710 can be concentrated and guided toward the irradiator 91. Accordingly, the irradiator 91 interferes with the air flow F2 and is cooled.

The second flow channel section 720 has a surface orthogonal to the second direction D2. A length d2 of the second flow channel section 720 in the first direction D1 is smaller than the length d1 of the first flow channel section 710 in the first direction D1. The length d2 is a length from an upper end to a lower end of the second flow channel section 720. A length w2 of the second flow channel section 720 in the third direction D3 is shorter than the length w1 of the first flow channel section 710 in the third direction D3. The length w2 is a length from a left end to a right end of the second flow channel section 720. Specifically, since the length d2 of the second flow channel section 720 in the first direction D1 is shorter than the length d1 of the first flow channel section 710 in the first direction D1, air is collected from above toward the second flow channel section 720 from the first flow channel section 710. Since the length w2 of the second flow channel section 720 in the third direction D3 is shorter than the length w1 of the first flow channel section 710 in the third direction D3, air is collected in the left-right direction from the first flow channel section 710 toward the second flow channel section 720.

The flow channel section 700 will be further described with reference to FIGS. 9, 13, and 14. As illustrated in FIGS. 9, 13, and 14, the flow channel section 700 has the third flow channel section 730 continuous with an end portion of the second flow channel section 720 in the direction opposite to the second direction D2. The third flow channel section 730 introduces air from the second flow channel section 720. The third flow channel section 730 includes a third guide portion 731 and a third opening 732.

The third guide portion 731 guides the air introduced from the second flow channel section 720 to the first space R1 (see FIG. 5). Specifically, the third guide portion 731 extends upward from an upper end portion of the second flow channel section 720. A length d3 of the third flow channel section 730 in the first direction D1 is longer than the length d1. The length d3 is a length from an upper end to a lower end of the third flow channel section 730. A length w3 of the third flow channel section 730 in the third direction D3 is longer than the length w2. The length w3 is a length from a left end to a right end of the third flow channel section 730.

As illustrated in FIG. 13, an opening area of the third opening 732 is the same as that of a third flow channel area S3. The third opening 732 corresponds to an end portion of the third flow channel section 730 in the direction opposite to the second direction D2. The third flow channel area S3 is a flow channel area of the third opening 732 orthogonal to the second direction D2. The third flow channel area S3 of the third flow channel section 730 is larger than the second flow channel area S2. Consequently, the negative pressure of the cooling fan 200 acting on the end portion of the second flow channel section 720 in the direction opposite to the second direction D2, that is, the negative pressure with respect to the reference pressure increases. That is, an air flow F3 becomes stronger, and a volume of air interfering with the irradiator 91 can be increased.

As illustrated in FIGS. 9, 13, and 14, the third flow channel section 730 is connected to the second flow channel section 720 with ribs 750. A pair of right and left ribs 750 extends from right and left end portions of the second guide portion 721 toward the third guide portion 731. Consequently, even in a case where the length d3 of the third flow channel section 730 in the first direction D1 is longer than the length d2, rigidity of the flow channel section 700 can be secured, and vibration sound can be reduced.

As illustrated in FIGS. 2 and 3, the discharge ports 41 discharge the air blown out by the cooling fan 200 to the outside of the housing 10. The discharge ports 41 are positioned on a side opposite to the suction ports 62 with respect to the opening 61. Since the discharge ports 41 are positioned on the side opposite to the suction ports 62 with respect to the opening 61, a separation distance between the suction ports 62 and the discharge ports 41 can be increased.

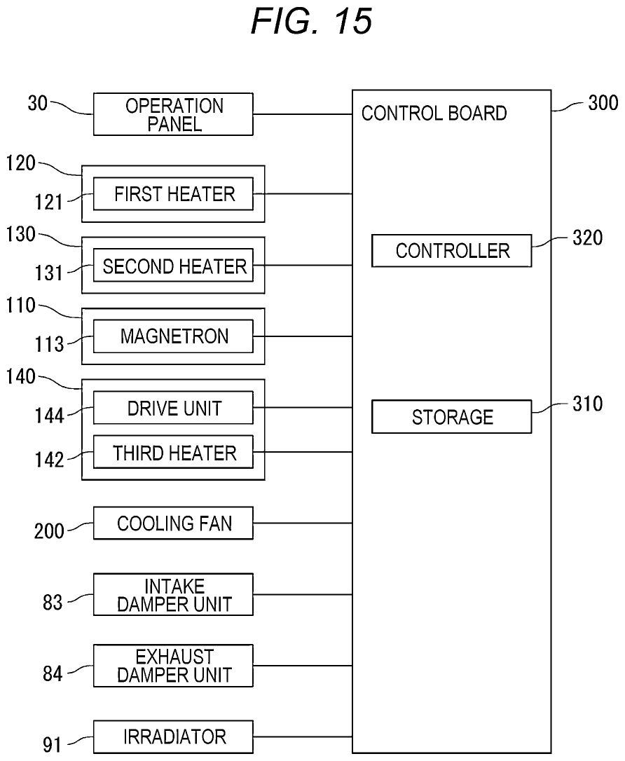

Next, the heating cooker 100 will be further described with reference to FIGS. 7 and 15. FIG. 15 is a block diagram illustrating a configuration of the heating cooker 100 according to the embodiment.

As illustrated in FIGS. 7 and 15, the heating cooker 100 further includes the right fan portion 220, the second wind direction plate 600, the control board 300, a high-voltage capacitor 330, and a high-voltage transformer 340.

The control board 300 includes a storage 310 and a controller 320. The storage 310 includes a random access memory (RAM) and a read only memory (ROM). The storage 310 stores control programs for controlling an operation of each component of the heating cooker 100.

The controller 320 is a hardware circuit including a processor such as a central processing unit (CPU). The controller 320 executes the control programs stored in the storage 310.

The high-voltage capacitor 330 is disposed between the left fan portion 210 and the right fan portion 220 and the suction ports 62.

The high-voltage transformer 340 is disposed between the right fan portion 220 and the suction ports 62 (see FIG. 5).

As illustrated in FIG. 7 again, the heating cooker 100 further includes a front duct member 234 and a rear duct member 230.

With reference to FIG. 15, a configuration of the heating cooker 100 will be described in detail. In the embodiment, the heating cooker 100 has, as heating cooking modes, a “microwave heating mode”, a “hot air circulation heating mode”, and a “grill heating mode”. The “microwave heating mode” is a mode for heating and cooking a heating-target object mainly by radiating microwaves into the heating cooking compartment 50. The “grill heating mode” means a mode for heating and cooking a heating-target object mainly by causing heat generated from the first heater unit 120 and the second heater unit 130 to radiate to the heating-target object. The “hot air circulation heating mode” is a mode for heating and cooking a heating-target object mainly by circulating hot air throughout the heating cooking compartment 50 to ensure a uniform temperature in the heating cooking compartment 50.

The controller 320 executes control programs stored in the storage 310, thereby controlling driving of the microwave supply unit 110, driving of the air blower 140, driving of the first heater unit 120, driving of the second heater unit 130, and driving of the cooling fan 200.

To be specific, the controller 320 controls the operation panel 30, the magnetron 113, the first heater 121, the second heater 131, the third heater 142, the drive unit 144, the cooling fan 200, the intake damper unit 83, and the exhaust damper unit 84. For example, in the case where the “microwave heating mode” is selected, the controller 320 drives the magnetron 113, the cooling fan 200, the intake damper unit 83, and the exhaust damper unit 84. In addition, in the case where the “grill heating mode” is selected, the controller 320 drives the first heater 121, the second heater 131, the cooling fan 200. Further, in the case where the “hot air circulation heating mode” is selected, the controller 320 drives the drive unit 144, the cooling fan 200, and drives at least one of the first heater 121, the second heater 131, and the third heater 142.

The embodiment of the present disclosure has been described above with reference to the drawings. However, the present disclosure is not limited to the above embodiment, and can be implemented in various aspects without departing from the gist thereof. For easy understanding, the drawings schematically illustrate the individual components mainly, and the thicknesses, lengths, number, and the like of the individual components illustrated in the drawings are different from actual ones for convenience of preparation of the drawings. In addition, the materials, shapes, dimensions, and the like of the individual components illustrated in the above embodiment are merely examples, and are not particularly limited, and various modifications can be made without substantially departing from the effects of the present disclosure.

(1) As described with reference to FIGS. 1 to 15, in the embodiment, an example in which the irradiator 91 has the light-emitting element 91a has been described, but the present disclosure is not limited thereto. A type of irradiator 91 is not limited, and any type such as an incandescent lamp, a halogen lamp, or an electrodeless lamp may be selected.

(2) As described with reference to FIGS. 1 to 15, in the embodiment, the state where the irradiator 91 is disposed on the upper wall 53 is provided, but the present disclosure is not limited thereto. The irradiator 91 may be disposed on any wall of the right wall 51, the left wall 52, the upper wall 53, the lower wall 54, or the rear wall 55.

(3) As described with reference to FIGS. 1 to 15, in the embodiment, the state where the first opening 53a and the second opening 53b are arranged in the left-right direction is provided, but the present disclosure is not limited thereto. The first opening 53a and the second opening 53b may be arranged in the front-rear direction. In addition, in a case where the first opening 53a and the second opening 53b are arranged in the front-rear direction, the first opening 53a and the second opening 53b may be arranged, for example, at the center of the right wall 51 or the left wall 52 in the front-rear direction. In addition, the opening shape is not limited to the elliptical shape. The opening shape may be a circular shape or a rectangular shape.

(4) As described with reference to FIGS. 1 to 15, in the embodiment, the state where the heating cooker 100 has, as heating cooking modes, a “microwave heating mode”, a “hot air circulation heating mode”, and a “grill heating mode” is provided, but the present disclosure is not limited thereto. The heating cooker 100 may have at least any one of the heating modes. The present disclosure provides a heating cooker, and has industrial applicability.

What is claimed is:

1. A heating cooker comprising:
a heating cooking compartment configured to accommodate a heating-target object;
a wall portion constituting at least a part of the heating cooking compartment;
an irradiator disposed on an outer side of the heating cooking compartment with respect to the wall portion and configured to irradiate an inside of the heating cooking compartment with light from an outside of the heating cooking compartment; and
a reflector disposed at a position on the wall portion opposite to the heating cooking compartment and configured to reflect light emitted from the irradiator,
wherein the wall portion has
a first opening configured to allow light emitted from the irradiator to pass through, and
a second opening configured to allow light reflected from the reflector to pass through.

2. The heating cooker according to claim 1, wherein
the reflector has an opening, and
the irradiator performs irradiation through the opening.

3. The heating cooker according to claim 2, wherein the first opening is provided at a position which at least partially overlaps the opening when viewed from an irradiation direction of the irradiator.

4. The heating cooker according to claim 3, wherein
a center of the first opening coincides with a center of the opening when viewed from the irradiation direction of the irradiator, and
an area of the opening is equal to or larger than an area of the first opening.

5. The heating cooker according to claim 2, wherein the second opening is provided at a position which does not overlap the opening when viewed from the irradiation direction of the irradiator.

6. The heating cooker according to claim 2, further comprising a transmissive member between the first opening and the second opening, and the opening,
wherein the transmissive member is provided to block communication between an inside and an outside of the heating cooking compartment via the first opening and the second opening.
